(19) United States
(12) Patent Application Publication
(10) Pub. No.: US 2025/0226555 A1
(43) Pub. Date: Jul. 10, 2025

(54) SERVICEABLE FUSE FOR A BATTERY ASSEMBLY

(71) Applicant: GM Global Technology Operations LLC, Detroit, MI (US)

(72) Inventors: Amar Sahib, Orion Township, MI (US); Jacob Lee Maxwell, Highland, MI (US); Timothy Glenn Ross, Washington, MI (US)

(21) Appl. No.: 18/404,042

(22) Filed: Jan. 4, 2024

(51) Int. Cl. H01M 50/583; H01M 50/249; H01M 50/503

(52) U.S. Cl. CPC H01M 50/583; H01M 50/249; H01M 50/503; H01M 2200/103; H01M 2220/20

(57) ABSTRACT

A rechargeable energy storage system (RESS) includes a housing having a plurality of walls that define a battery cell receiving zone. A plurality of battery cells is arranged in the battery cell receiving zone. A first electrical connector is connected to the plurality of battery cells, a second electrical connector connected to the plurality of battery cells, and an electric circuit is defined between the first electrical connector, the second electrical connector, the plurality of battery cells, and an electrical load. A fuse is connected in the electric circuit. The fuse is provided on the housing and is configured to create an open in the electric circuit.

### INTRODUCTION

The subject disclosure relates to power supplies, and in particular to a serviceable fuse for a battery assembly.

Many newer vehicles are being manufactured with electric propulsion systems. The electric propulsion system, be it a full electric system or a hybrid electric system, relies on an electric motor that is powered by energy stored in a rechargeable energy storage system (RESS) or battery. The battery receives, stores, and discharges electric energy into a load, such as a drive unit that provides motive energy for the vehicle.

The battery typically includes a plurality of cells that store and discharge the electric energy. For a variety of reasons, the battery may discharge energy through an electrical circuit at a rate that exceeds design thresholds or may be charged through the electrical circuit by an energy supply that does not meet design requirements. At such time, it is desirable to disconnect the battery cells from the electric motor.

Currently, batteries include a fuse that is responsive to an over current condition to interrupt or create an open electrical circuit. In many instances, the fuse is a fast acting fuse that may employ an amount of pyrotechnic material to break contacts and open the electrical circuit. The fuse, when triggered, quickly opens the electrical circuit to protect internal battery components. The fuse is a single use device that, once triggered, requires replacement. Currently replacing the fuse is a time consuming and work intensive endeavor typically requiring disassembly of underbody panels and removal and disassembly of the battery. Accordingly, it is desirable to provide a fuse that is readily accessible and easily replaceable.

### SUMMARY

A rechargeable energy storage system (RESS), in accordance with a non-limiting example, includes a housing having a plurality of walls that define a battery cell receiving zone. A plurality of battery cells is arranged in the battery cell receiving zone. A first electrical connector is connected to the plurality of battery cells, a second electrical connector connected to the plurality of battery cells, and an electric circuit is defined between the first electrical connector, the second electrical connector, the plurality of battery cells, and an electrical load. A fuse is connected in the electric circuit. The fuse is provided on the housing and is configured to create an open in the electric circuit.

In addition to one or more of the features described herein the fuse is mounted to one of the plurality of walls.

In addition to one or more of the features described herein the housing includes a cover, the fuse being mounted to the cover.

In addition to one or more of the features described herein a battery disconnect unit is arranged in the housing, the fuse being mounted to the battery disconnect unit.

In addition to one or more of the features described herein the fuse includes a base portion mounted to the RESS and an electrical contact portion that is selectively removeable from the base portion.

In addition to one or more of the features described herein the fuse includes a handle pivotally mounted to the electrical contact portion.

In addition to one or more of the features described herein the fuse includes a latch element that secures the electrical contact portion to the base portion.

In addition to one or more of the features described herein the fuse is a pyro fuse including a pyro element that selectively creates the open.

In addition to one or more of the features described herein the pyro element is part of the electrical contact portion.

In addition to one or more of the features described herein the electric circuit includes a positive portion and a negative portion, the fuse being arranged in the positive portion between the plurality of battery cells and the electrical load.

A vehicle in accordance with a non-limiting example, includes a body, an electric drive unit supported in the body, and a rechargeable energy storage system (RESS) electrically connected to the electric drive unit. The RESS includes a housing having a plurality of walls that define a battery cell receiving zone, a plurality of battery cells arranged in the battery cell receiving zone. A first electrical connector is connected to the plurality of battery cells, a second electrical connector is connected to the plurality of battery cells, and an electric circuit is defined between the first electrical connector, the second electrical connector, the plurality of battery cells, and the electric drive unit. A fuse is connected in the electric circuit. The fuse is provided on the housing and configured to create an open in the electric circuit.

In addition to one or more of the features described herein the fuse is mounted to one of the plurality of walls.

In addition to one or more of the features described herein the housing includes a cover, the fuse being mounted to the cover.

In addition to one or more of the features described herein a battery disconnect unit is arranged in the housing, the fuse being mounted to the battery disconnect unit.

In addition to one or more of the features described herein the fuse includes a base portion mounted to the RESS and an electrical contact portion that is selectively removeable from the base portion.

In addition to one or more of the features described herein the fuse includes a handle pivotally mounted to the electrical contact portion.

In addition to one or more of the features described herein the fuse includes a latch element that secures the electrical contact portion to the base portion.

In addition to one or more of the features described herein the fuse is a pyro fuse including a pyro element that selectively creates the open.

In addition to one or more of the features described herein the pyro element is part of the electrical contact portion.

In addition to one or more of the features described herein the electric circuit includes a positive portion and a negative portion, the fuse being provided in the positive portion between the plurality of battery cells and the electric drive unit.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly having a serviceable fuse, in accordance with a non-limiting example;

FIG. 2 is a perspective view of a battery assembly including a serviceable fuse, in accordance with a non-limiting example;

FIG. 3 is a schematic diagram illustrating a serviceable fuse connected between battery cells of the battery assembly of FIG. 2 and a load, in accordance with a non-limiting example;

FIG. 4 is a perspective view of the serviceable fuse of FIG. 2, in accordance with a non-limiting example;

FIG. 5 is a perspective view of a latch mechanism of the serviceable fuse of FIG. 4 being disengaged, in accordance with a non-limiting example;

FIG. 6 is a perspective view of the serviceable fuse of FIG. 5 showing an electrical contact portion being removed from a base portion, in accordance with a non-limiting example;

FIG. 7 shows a serviceable fuse mounted to a battery disconnect unit of the battery assembly, in accordance with a non-limiting example; and

FIG. 8 shows a serviceable fuse mounted to a side wall of a housing of the battery assembly, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

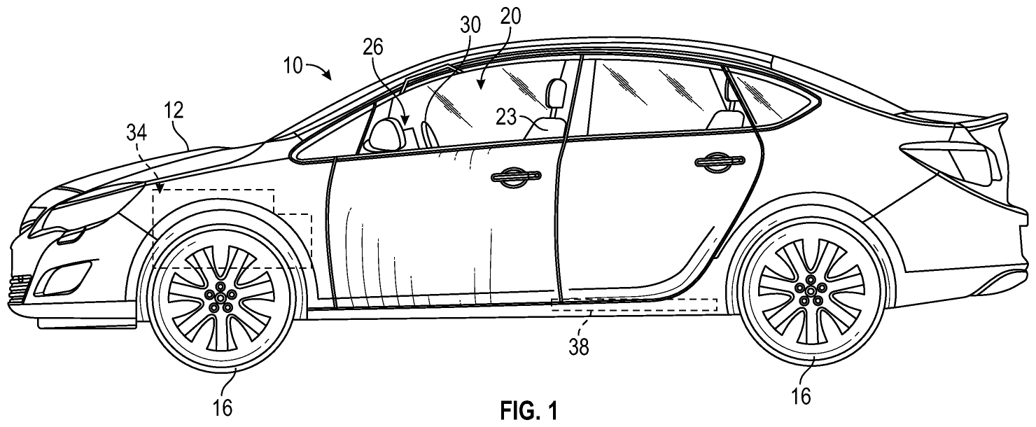

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electrical load shown in the form of an electric drive unit 34. Electric drive unit 34 provides power to one or more of the plurality of wheels 16.

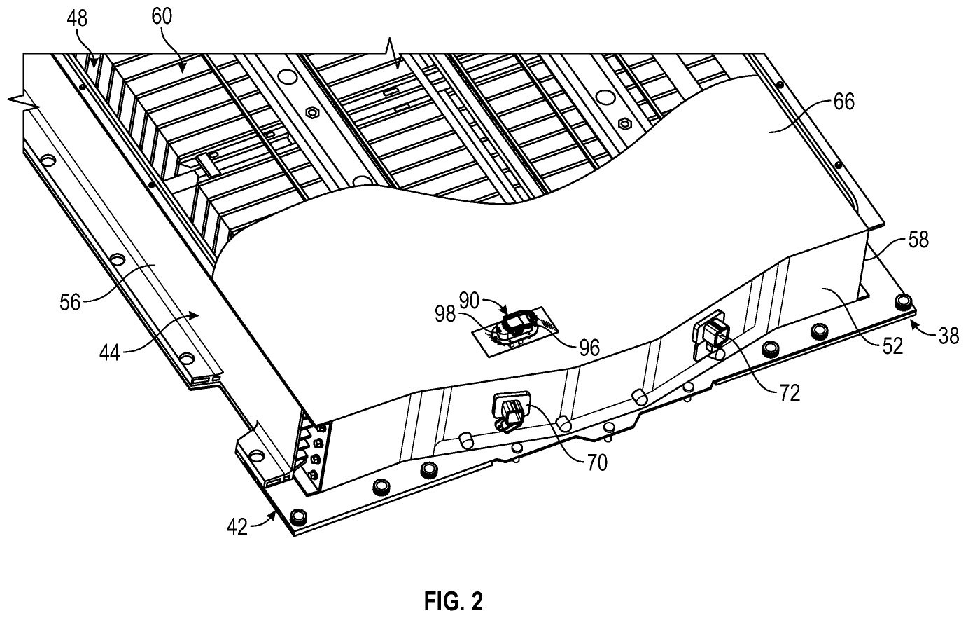

A rechargeable energy storage system (RESS) or battery assembly 38 is arranged in body 12 and provides power to electric drive unit 34. In other arrangements, a fuel cell may be used to provide power to electric drive unit 34. At this point, it should be understood that the location of electric drive unit 34 and battery assembly 38 may vary. In a non-limiting example shown in FIG. 2, RESS 38 includes a housing 42 having a plurality of walls 44 defining a battery cell receiving zone 48. At this point it should be understood that while battery assembly 38 is shown in connection with vehicle 10, the non-limiting examples described herein may be employed in battery assemblies used in a wide range of applications and should not be considered as being limited to vehicle power systems.

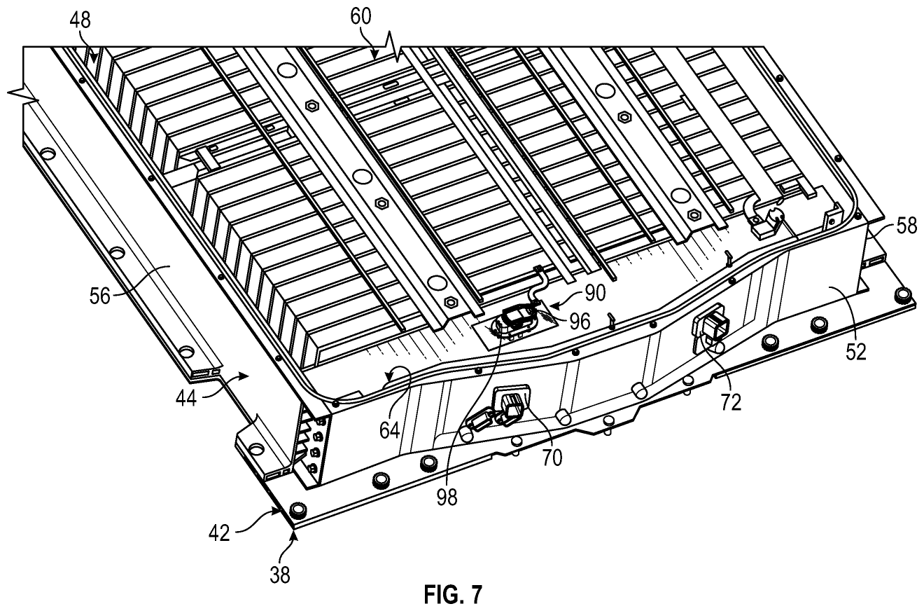

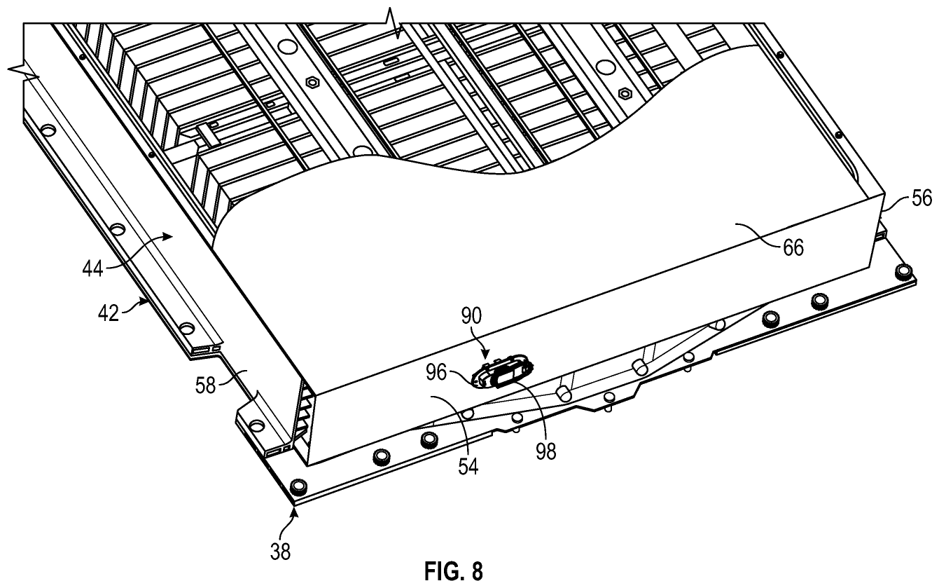

With continued reference to FIG. 2, plurality of walls 44 include at least a first end wall 52, a second end wall 54 (FIG. 8), a first side wall 56, and a second side wall 58. Housing 42 encloses a plurality of battery cells 60 and a battery disconnect unit (BDU) 64 (FIG. 7). BDU 64 is arranged between the plurality of battery cells 60 and first end wall 52. A cover 66 is arranged on housing 42 to protect the plurality of battery cells 60 and BDU 64.

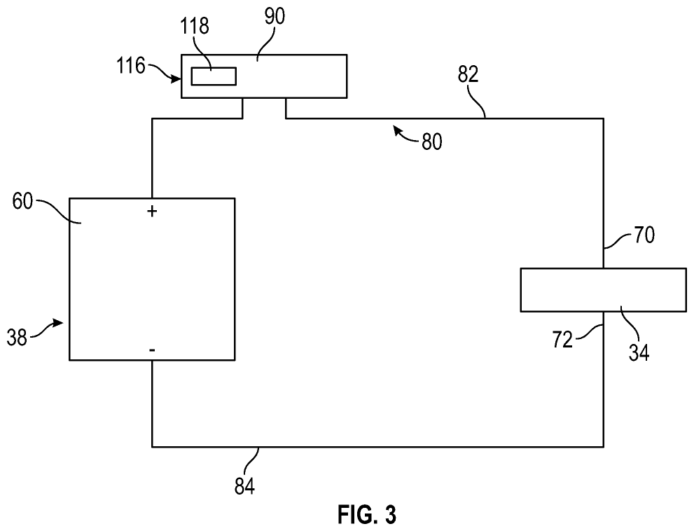

In a non-limiting example, a first electrical connector 70 and a second electrical connector 72 are mounted to first end wall 52. As shown in FIG. 3, an electric circuit 80 is defined between first electrical connector 70 and second electrical connector 72. Electric circuit 80 couples the plurality of battery cells 60 with high voltage vehicle components such as electric drive unit 34. In a non-limiting example, electric circuit 80 includes a positive portion 82 that extends between a positive terminal (not separately labeled) of battery assembly 38 and first electrical connector 70 and a negative portion 84 that extends between a negative terminal (also not separately labeled) of battery assembly 38 and second electrical connector 72.

In a non-limiting example, battery assembly 38 includes a fuse 90 arranged in electric circuit 80. In one non-limiting example, fuse 90 is mounted to cover 66 (FIG. 2) and positioned to interrupt a flow of current passing through positive portion 82 of electric circuit 80 to electric drive unit 34.

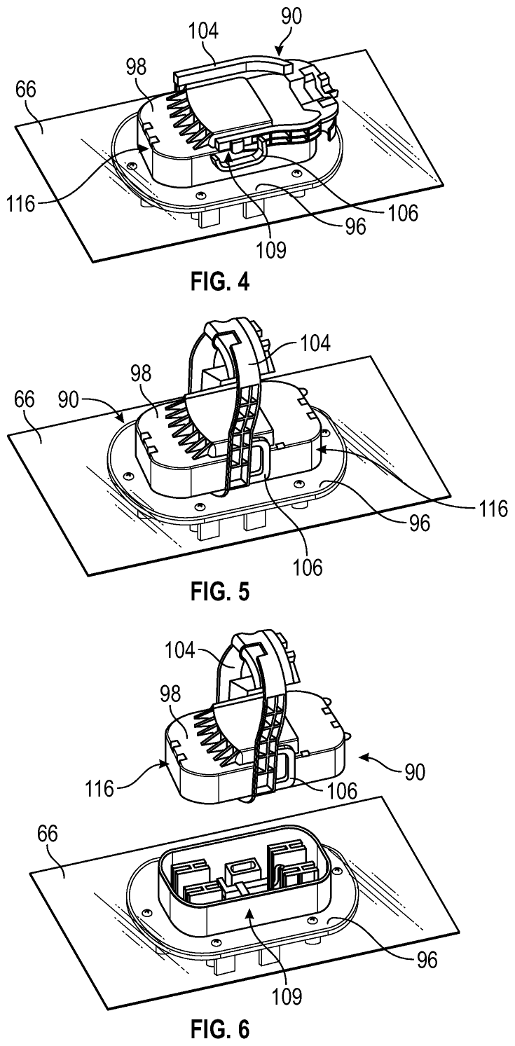

Referring to FIG. 4, fuse 90 includes a base portion 96 and an electrical contact portion 98. Electrical contact portion 98 is detachably connected to base portion 96. When electrical contact portion 98 is connected to base portion 96 electrical current flows through electric circuit 80 from the plurality of battery cells 60 to electric drive unit 34. When electrical contact portion 98 is removed from base portion 96, an open circuit is created interrupting electrical current flow. In one non-limiting example, electrical contact portion 98 includes a handle 104 having a latch element 106. Base portion 96 includes a projection 109 that aligns with handle 104 and is selectively engaged by latch element 106.

To remove electrical contact portion 98 from base portion 96 handle 104 is rotated as shown in FIG. 5. Rotation of handle 104 disengages latch element 106 from projection 109. When latch element 106 is disengaged from projection 109, electrical contact portion 98 may be removed from base portion 96 as shown in FIG. 6 to interrupt a flow of electricity from battery assembly 38 to electrical circuit 80. By arranging fuse 90 in a readily accessible area, (e.g., cover 66), electrical current may be more easily cut off during servicing of vehicle 10. Further, in the event of a fuse failure, replacement of electrical contact portion 98 may be achieved without the need to disassemble battery assembly 38 from vehicle 10.

In addition to interrupting electrical current flow by removing electrical contact portion 98 from base portion 96, fuse 90 will also interrupt electrical current flow upon detecting an over current condition. That is, if current draw on first plurality of battery cells 60 exceeds a defined threshold, fuse 90 will trip, creating an open in first circuit 80. In a non-limiting example, current detection may be performed by an additional circuit (not shown) located inside the electrical contact portion 98.

Current detection may also be performed by a circuit (not shown) external to electrical contact portion 98, with a discrete signal used to trip fuse 90. It should be understood that tripping the fuse 90 is not limited to situations of overcurrent inside the battery. Fuse 90 may be triggered from a variety of discrete signals from external sources, for a variety of situations that require quick disconnection of the high voltage circuit, including, for example, upon detecting forces that might trigger a supplemental restraint.

In a non-limiting example, fuse 90 takes the form of a pyro fuse 116 having a pyro element 118 as shown in FIG. 3. Pyro element 118 is selectively activated to create the open electric circuit 80. Pyro element 118 ensures that first fuse 90 reacts quickly to a need to disconnect battery high voltage such as an over current condition, supplemental restraint deployment and the like. In a non-limiting example, pyro element 118 will open electric circuit 80 in 2 milliseconds or less. The use of pyro element 118 ensures a rapid response to an over current condition or other triggering events with limited response variability.

At this point, it should be understood that the location of fuse 90 may vary. That is, depending on vehicle make, model, and/or accessories, fuse 90 may be arranged in different locations on battery assembly 38. For example, as shown in FIG. 7, in one non-limiting example, fuse 90 may be mounted to BDU 64 below cover 66. When mounted to BDU 64, fuse 90 may be accessible through cover 66. In another non-limiting example, fuse 90 may be mounted to second end wall 54 as shown in FIG. 8. The mounting location is chosen for ease of accessibility to fuse 90 for technicians and other service personnel. In another non-limiting example, multiple pluralities of battery cells may provide energy to the BDU. In such a non-limiting example, battery assembly 38 may include multiple fuses. Regardless, it should be understood that by being located in a readily accessible area, in addition to disrupting power when detecting a triggering event (e.g., an over current condition, crash forces, and the like) the fuse can also serve as a manual service disconnect (MSD) that allows a technician to isolate electric components from a source of high voltage electricity during servicing.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A rechargeable energy storage system (RESS), the RESS comprising:
a housing having a plurality of walls that define a battery cell receiving zone;
a plurality of battery cells arranged in the battery cell receiving zone;
a first electrical connector connected to the plurality of battery cells;
a second electrical connector connected to the plurality of battery cells;
an electric circuit defined between the first electrical connector, the second electrical connector, the plurality of battery cells, and an electrical load; and
a fuse connected in one of the electric circuit, the fuse provided on the housing and being configured to create an open in the electric circuit.

2. The RESS according to claim 1, wherein the fuse is mounted to one of the plurality of walls.

3. The RESS according to claim 1, wherein the housing includes a cover, the fuse being mounted to the cover.

4. The RESS according to claim 1, further comprising a battery disconnect unit arranged in the housing, the fuse being mounted to the battery disconnect unit.

5. The RESS according to claim 1, wherein the fuse includes a base portion mounted to the RESS and an electrical contact portion that is selectively removeable from the base portion.

6. The RESS according to claim 5, wherein the fuse includes a handle pivotally mounted to the electrical contact portion.

7. The RESS according to claim 6, wherein the fuse includes a latch element that secures the electrical contact portion to the base portion.

8. The RESS according to claim 5, wherein the fuse is a pyro fuse including a pyro element that selectively creates the open.

9. The RESS according to claim 8, wherein the pyro element is part of the electrical contact portion.

10. The RESS according to claim 1, wherein the electric circuit includes a positive portion and a negative portion, the fuse being arranged in the positive portion between the plurality of battery cells and the electrical load.

11. A vehicle comprising:
a body;
an electric drive unit supported in the body; and
a rechargeable energy storage system (RESS) electrically connected to the electric drive unit, the RESS comprising:
a housing having a plurality of walls that define a battery cell receiving zone;
a plurality of battery cells arranged in the battery cell receiving zone;
a first electrical connector connected to the plurality of battery cells;
a second electrical connector connected to the plurality of battery cells;
an electric circuit defined between the first electrical connector, the second electrical connector, the plurality of battery cells, and the electric drive unit; and
a fuse connected in the electric circuit, the fuse being provided on the housing and configured to create an open in the electric circuit.

12. The vehicle according to claim 11, wherein the fuse is mounted to one of the plurality of walls.

13. The vehicle according to claim 11, wherein the housing includes a cover, the fuse being mounted to the cover.

14. The vehicle according to claim 11, further comprising a battery disconnect unit arranged in the housing, the fuse being mounted to the battery disconnect unit.

15. The vehicle according to claim 11, wherein the fuse includes a base portion mounted to the RESS and an electrical contact portion that is selectively removeable from the base portion.

16. The vehicle according to claim 15, wherein the fuse includes a handle pivotally mounted to the electrical contact portion.

17. The vehicle according to claim 16, wherein the fuse includes a latch element that secures the electrical contact portion to the base portion.

18. The vehicle according to claim 15, wherein the fuse is a pyro fuse including a pyro element that selectively creates the open.

19. The vehicle according to claim 18, wherein the pyro element is part of the electrical contact portion.

20. The vehicle according to claim 11, wherein the electric circuit includes a positive portion and a negative portion, the fuse being provided in the positive portion between the plurality of battery cells and the electric drive unit.
